(19) United States
(12) Patent Application Publication
(10) Pub. No.: US 2017/0185105 A1
(43) Pub. Date: Jun. 29, 2017

(54) PROTECTIVE LAYER AND ELECTRONIC DEVICE

(71) Applicant: Lenovo (Beijing) Limited, Beijing (CN)

(72) Inventors: Xiaoli Fan, Beijing (CN); Lei Ma, Beijing (CN); Changlong Zuo, Beijing (CN)

(21) Appl. No.: 15/258,644

(22) Filed: Sep. 7, 2016

(30) Foreign Application Priority Data
Dec. 24, 2015 (CN) 201510983369.3

(51) Int. Cl. G06F 1/16

(52) U.S. Cl. CPC G06F 1/1652; G06F 1/1656

(57) ABSTRACT

Disclosed is a protective layer of a display screen including but not limited to: a flexible abradable fibrous layer laid flat in an elastic substrate; and an elastic substrate, wherein the adhesive strength between the elastic substrate and the fibrous layer, and the adhesive strength between the elastic substrate and a surface of the display screen are selected to obtain a desired transparency of the protective layer. Other aspects are described and claimed.

### CLAIM FOR PRIORITY

This application claims priority to Chinese Application No. 201510983369.3, filed on Dec. 24, 2015, the contents of which are fully incorporated by reference herein.

### TECHNICAL FIELD

The subject matter relates to the field of electronic technologies, and in particular, to a protective layer and an electronic device.

### BACKGROUND

Currently, with the development of electronic information technologies, intelligent electronic devices such as a smartphone, a tablet computer, and a notebook computer are increasingly popularized. To prevent a display screen of an electronic device from being scratched and leaving a mark, people generally attach a protective film to the display screen of the electronic device or manufacture a protective layer, so as to ensure durability and a long-term effective visible effect of the display screen.

However, when a display screen of an electronic device uses a flexible display screen, because the flexible display screen needs to be bent and deformed during use, a protective film or a protective layer attached to the flexible display screen also needs to be deformed accordingly. Therefore, the protective film or the protective layer applied to the flexible display screen is required to have both good abrasion resistance and good flexibility.

Conventionally, there are two types of protective layers applicable to a flexible display screen. One type is a protective layer made of ultra-thin glass, but the protective layer of the ultra-thin glass is very difficult to be processed, and is easy to be broken, which greatly affects durability of a product.

The other type is a protective film of a display screen that is processed by using a conventional surface hardening treatment technology, but the protective film that is processed and produced in this manner is either too hard, easily causing the protective film to be broken when the protective film is bent or is too soft, causing the protective film to be easily scratched.

### BRIEF SUMMARY

In summary, one aspect provides a product, comprising: a protective layer of a flexible display screen, including: an elastic substrate that adheres to a surface of the flexible display screen, and a fibrous layer arranged at least partially in the elastic substrate.

Another aspect provides an electronic device, comprising: a processor; a flexible display screen operatively coupled to the processor; and a protective layer affixed to the flexible display screen, wherein the protective layer comprises: an elastic substrate that adheres to a surface of the flexible display screen, and a fibrous layer arranged at least partially in the elastic substrate.

A further aspect provides a method, comprising: obtaining a protective layer for a flexible display screen of an electronic device, wherein the protective layer comprises: an elastic substrate that adheres to a surface of the flexible display screen, and a fibrous layer arranged at least partially in the elastic substrate; and applying the protective layer to a flexible display screen of the electronic device.

The foregoing is a summary and thus may contain simplifications, generalizations, and omissions of detail; consequently, those skilled in the art will appreciate that the summary is illustrative only and is not intended to be in any way limiting.

For a better understanding of embodiments, together with other and further features and advantages thereof, reference is made to the following description, taken in conjunction with the accompanying drawings, and the scope of the invention will be pointed out in the appended claims.

### BRIEF DESCRIPTION OF THE SEVERAL VIEWS OF THE DRAWINGS

FIG. 1 is a structural diagram of an example protective layer for a device according to an embodiment.

FIG. 2 is a front structural diagram and a side structural diagram of an example embodiment.

FIG. 3 shows an example protective layer for a device according to an embodiment.

FIG. 4 shows an example protective layer for a device according to an embodiment.

FIG. 5 shows an example protective layer for a device according to an embodiment.

### DETAILED DESCRIPTION

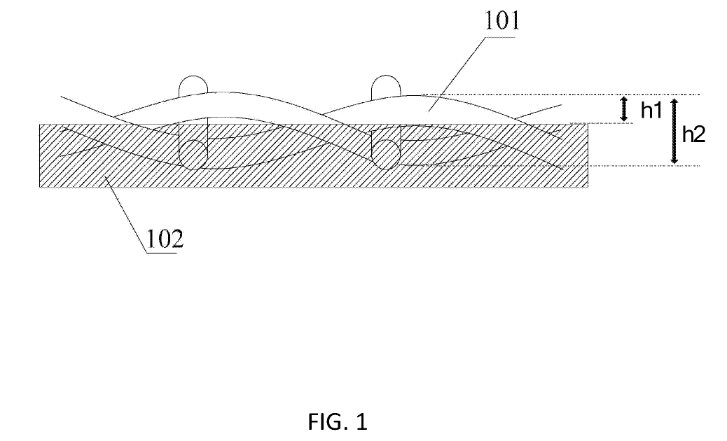

It will be readily understood that the components of the embodiments, as generally described and illustrated in the figures herein, may be arranged and designed in a wide variety of different configurations. Thus, the following more detailed description of the embodiments of the apparatus, system, and method, as represented in FIGS. 1 through 5 is not intended to limit the scope of the embodiments, as claimed, but is merely representative of selected embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

Referring to FIG. 1, an embodiment provides a protective layer of a display screen, including: a fibrous layer 101, laid flat in an elastic substrate, wherein the fibrous layer may be made of a material with preset flexibility and preset abradable characteristic (abradability); and an elastic substrate 102, having a preset elasticity, wherein adhesive strength between the elastic substrate and the fibrous layer and adhesive strength between the elastic substrate and a surface of the display screen are greater than or equal to a preset adhesive strength; wherein, a transparency of the protective layer is greater than or equal to a preset transparency.

The fibrous layer may be made of a material with high flexibility and high abrasion resistance, for example, a modified polyurethane fiber, a glass fiber, or alumina fiber. In order not to affect light transmission of the protective layer, the fibrous layer may also use a transparent fiber material. Any fiber material that is not easily broken and has an anti-scratch function when bending and deformation occur may be used as the fibrous layer.

The elastic substrate may be made of a material with some elasticity and abrasion resistance after forming, and may further achieve a function of fixing the fibrous layer relative to the surface of the display screen after forming. Because the elastic substrate has some elasticity, when the display screen is bent and deformed, the elastic substrate is not easily broken and has good abrasion resistance. An elastic substrate may be made of an aliphatic polyurethane elastomer, a modified organosilicon elastomer, an acrylate material, a polyester or polyamide material, or the like. In order not to affect the light transmission of the protective layer, the elastic substrate may also be made of a transparent material.

When the fibrous layer is made of a flaky material, the flaky fibrous layer may be laid flat in the elastic substrate, or when the fibrous layer is made of mutually independent particle materials, the fibrous layer may be laid flat in the elastic substrate in a discrete manner. Therefore, any manner of laying the fibrous layer flat may be utilized as desired as long as the elastic substrate can effectively fix the fibrous layer after forming, and the transparency of the formed protective layer is greater than or equal to the preset transparency.

A technical solution of the embodiments is that a weave fiber with high tensile strength and breaking resistance may be used to improve an anti-scratch and anti-cutting capability of the surface, so that the fibrous layer can bear most of an external force, and can further perform dispersive transferring by means of a fiber weaving structure and limited elastic deformation of the elastic substrate based on external force, so as to reduce damage.

A fibrous layer that is made of a material with a preset flexibility and a preset abradability may be combined with an elastic substrate that has a preset elasticity for affixing to the fibrous layer, so as to form a protective layer of a display screen that has both good abrasion resistance and good flexibility. A technical solution of the embodiments is improving abrasion resistance and flexibility of the protective layer of the display screen, and further improving applicability of the protective layer of the display screen.

Optionally, the material of the fibrous layer may be similar to and may be soluble in the elastic substrate, so that the adhesive strength between the fibrous layer and the elastic substrate is greater than or equal to the preset adhesive strength.

Optionally, a fibrous layer may be coated with a surfactant, so that the adhesive strength between the fibrous layer and the elastic substrate is greater than or equal to the preset adhesive strength.

In order to improve the adhesive strength between the elastic substrate and the fibrous layer, so as to improve an effect of fixing the fibrous layer by the elastic substrate, two manners may be used to improve the adhesive strength between the elastic substrate and the fibrous layer. One manner is that an elastic substrate material that is similar to and is soluble in the fibrous layer may be used. The other manner is that in a process of processing the protective layer, before the elastic substrate is bonded with the fibrous layer, the fibrous layer may be coated with a surfactant that can be effectively adhered to both the elastic substrate and the fibrous layer, thereby achieving an effect of indirectly improving the adhesive strength between the elastic substrate and the fibrous layer.

A technical solution of the embodiments includes a fibrous layer that is similar to and soluble in a material of the elastic substrate may be used, or the fibrous layer may be coated with a surfactant that can be effectively adhered to both the elastic substrate and the fibrous layer, so that adhesive strength between the fibrous layer and the elastic substrate is greater than or equal to the preset adhesive strength, which achieves a function of improving fixing of the fibrous layer by the elastic substrate, thereby achieving a technical effect of improving stability of the protective layer.

Optionally, a difference between a refractive index of the fibrous layer and a refractive index of the elastic substrate may be less than or equal to a preset threshold, so that the fibrous layer and the elastic substrate are integrally presented.

When refractive indexes of two materials are closer, visual effects presented by the two materials are closer to the same and compatible with each other. When the difference between the refractive index of the fibrous layer and the refractive index of the elastic substrate is less than or equal to the preset threshold, it indicates that the refractive index of the fibrous layer is close to the refractive index of the elastic substrate, so that the protective layer does not cause the fibrous layer to separate from the elastic substrate, and does not cause a result of distortion of an image displayed on the display screen.

A technical solution of the embodiments includes a difference between a refractive index of the fibrous layer and a refractive index of the elastic substrate may be further set to be less than or equal to a preset threshold, so that the protective layer does not cause the fibrous layer to separate from the elastic substrate, which has a technical effect of reducing image distortion on the display screen.

Optionally, a cross-sectional diameter of the material of the fibrous layer may be less than or equal to a visible wavelength, so that the transparency of the protective layer is greater than or equal to the preset transparency.

The elastic substrate may be made of a transparent and clear material, which does not shield light. When the cross-sectional diameter of the material of the fibrous layer is less than or equal to the visible wavelength, the fibrous layer does not shield light, so that forming of the protective layer is close to a completely transparent state, thereby improving definition of the display screen.

A technical solution of the embodiments includes a cross-sectional diameter of the material of the fibrous layer that is further set to be less than or equal to a visible wavelength, to improve transparency of the protective layer, thereby improving definition of the display screen.

Optionally, a ratio of a height of the fibrous layer exposed from the elastic substrate to a thickness of the fibrous layer may be a preset ratio.

As shown in FIG. 1, a structural diagram of an example according to embodiments is illustrated. By increasing the height h1 of the exposed fibrous layer from an elastic substrate, the abrasion resistance of the protective layer is increased but the distortion of the image displayed on a display screen is increased. By decreasing the height h1 of an exposed fibrous layer from an elastic substrate, the abrasion resistance of the protective layer is decreased and less distortion results for an image displayed on the display screen. The ratio of the height h1 of the exposed fibrous layer to the thickness h2 of an elastic substrate may be set to a preset ratio as desired so that the protective layer may have some abrasion resistance but cause little image distortion.

A technical solution of the embodiments includes a preset ratio that is used when selecting a ratio of a height of the fibrous layer exposed from the elastic substrate to a thickness of the fibrous layer, thereby achieving a technical effect of making the protective layer have some abrasion resistance and cause little image distortion.

Optionally, the fibrous layer is a mesh structure layer in which meshes may be evenly distributed and parallel to a surface of the elastic substrate, so that light transmission of the protective layer may be the same per unit area.

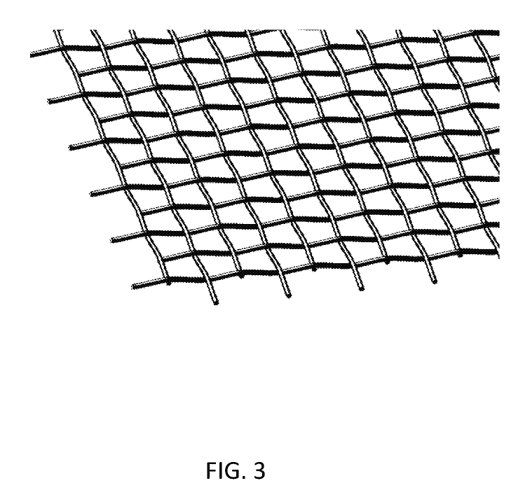

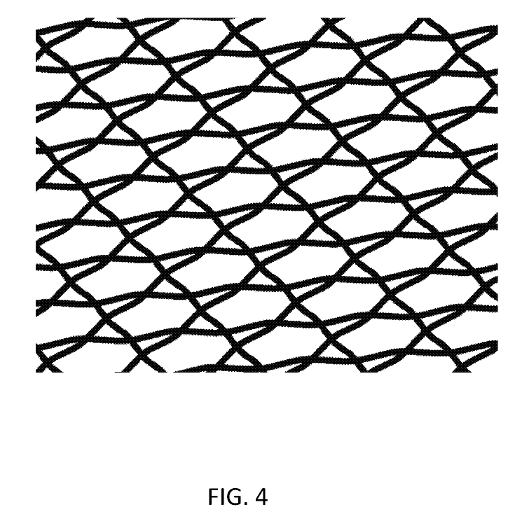

A multiple weaving manner may be used to make the fibrous layer a mesh structure layer in which meshes are evenly distributed, and the mesh structure may further have multiple different types according to a mesh shape or a weaving manner. For example, as shown in FIG. 3, a mesh structure may be woven in a tabby manner, in which quadrilateral meshes are evenly distributed, or, as shown in FIG. 4, a mesh structure may be woven in three directions in a plane, in which polygonal meshes are evenly distributed. After the fibrous layer is obtained by means of weaving in a specific manner, the fibrous layer of the mesh structure in which meshes are evenly distributed may be laid parallel to the elastic substrate, so that the fibrous layer may be parallel to the surface of the elastic substrate.

A technical solution of the embodiments provides a fibrous layer that is further set to a mesh structure layer in which meshes are uniformly distributed and parallel to a surface of an elastic substrate, so that light transmission of the protective layer is the same per unit area, which has a technical effect of improving a display effect of the display screen. Optionally a fibrous layer may include multiple fibers that are parallel to each other and are arranged at equal intervals.

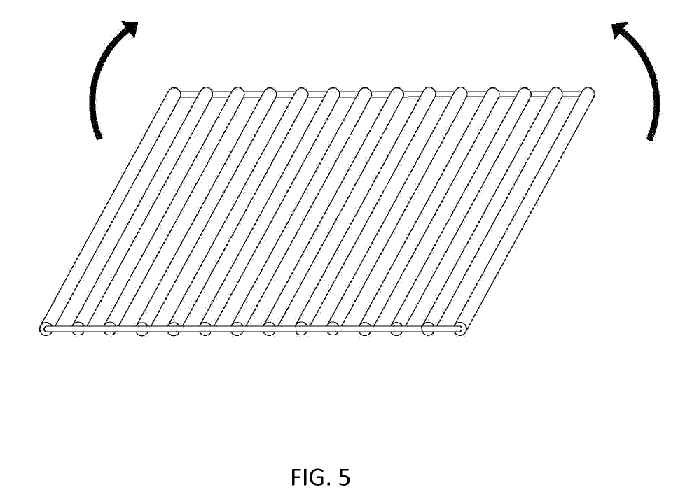

The fibrous layer may be formed by multiple fibers that are parallel to each other and are arranged at equal intervals. As shown in FIG. 5, a central part corresponding to a light transmission part of the display screen may also be formed by multiple fibers that are parallel to each other and are arranged at equal intervals, and a frame part may be formed by fibers that are arranged along another direction, which may be set for the desired effect. Optionally, materials of the multiple fibers may be high rigidity fibers.

When the fibrous layer includes multiple fibers that are parallel to each other and are arranged at equal intervals, high rigidity fibers may be used as materials, which may improve the abrasion resistance of the protective layer and may improve rigidity along a fiber axis direction, and further, the fibrous layer may be bent along a direction perpendicular to a fiber axis with a flexible display screen. As shown in FIG. 5, multiple high rigidity fibers may be used in the center, and materials with good flexibility may be used on two sides to connect to the multiple high rigidity fibers, so that the fibers may be parallel to each other and may be arranged at equal intervals is presented, and a formed high rigidity fiber layer may be bent and deformed along a direction indicated by the arrows without breaking the high rigidity fibers.

A technical solution of the embodiments includes the fibrous layer may be further set to have multiple fibers that are parallel to each other and that are arranged at equal intervals, and a manner in which materials of the multiple fibers are set to high rigidity fibers may be further combined, so as to improve the abrasion resistance of the protective layer, thereby having a technical effect that the protective layer may be deformed along a particular direction and is not broken.

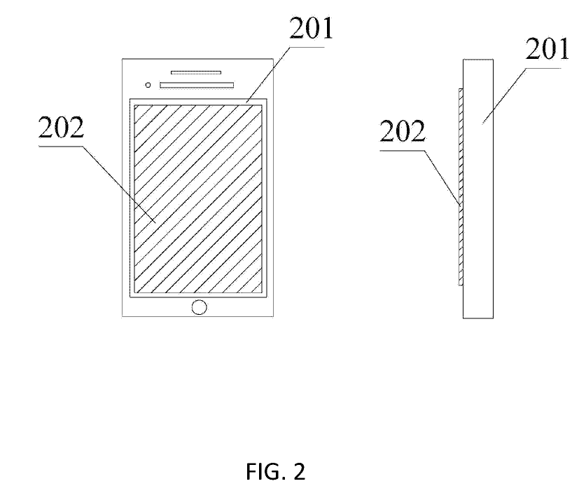

Referring back to FIG. 2, an electronic device comprises: a display screen 201; and the protective layer 202 described herein, wherein the protective layer 202 may be attached to a screen surface of the display screen.

Optionally, the fibrous layer may include multiple fibers that are parallel to each other and may be arranged at equal intervals, and when the display screen 201 is bent and deformed, a folding track produced by the display screen 201 may be parallel to the multiple fibers, and a protective layer 202 may be bent and deformed at the same time, so that the fibrous layer may be parallel to the screen surface.

Various variations and specific embodiments of the protective layer in the example embodiment illustrated in FIG. 1 are also applicable to an electronic device based on the foregoing detailed descriptions of the protective layers, persons skilled in the art may clearly know an implementation manner of the electronic device in this embodiment, and for brevity of the specification, details are not repeated herein.

A technical solution of the embodiments provides that a fibrous layer made of a material with a preset flexibility and a preset abradability may be combined with an elastic substrate that has a preset elasticity and that achieves a function of fixing the fibrous layer, so as to form a protective layer of a display screen that has both good abrasion resistance and good flexibility. A technical solution of the embodiments provides improving abrasion resistance and flexibility of the protective layer of the display screen, and further has a technical effect of improving applicability of the protective layer of the display screen.

A technical solution of the embodiments provides a fibrous layer that is similar to and soluble in a material of the elastic substrate, which may be used or the fibrous layer may be coated with a surfactant that may be effectively adhered to both the elastic substrate and the fibrous layer, so that adhesive strength between the fibrous layer and the elastic substrate is greater than or equal to the preset adhesive strength, which achieves a function of improving fixing of the fibrous layer by the elastic substrate, thereby achieving a technical effect of improving stability of the protective layer.

A technical solution of the embodiments provides that the difference between a refractive index of the fibrous layer and a refractive index of the elastic substrate may be further set to be less than or equal to a preset threshold, so that the protective layer does not cause the fibrous layer to separate from the elastic substrate, which has a technical effect of reducing image distortion on the display screen.

A technical solution of the embodiments provides that a cross-sectional diameter of the material of the fibrous layer may be further set to be less than or equal to a visible wavelength, to improve transparency of the protective layer, thereby having a technical effect of improving definition of the display screen.

A technical solution of the embodiments provides that a manner in which a ratio of a height of the fibrous layer exposed from the elastic substrate to a thickness of the fibrous layer is set to a preset ratio, thereby achieving a technical effect of making the protective layer have some abrasion resistance and cause little image distortion.

A technical solution of the embodiments provides the fibrous layer may be further set to a mesh structure layer in which meshes are uniformly distributed and parallel to a surface of the elastic substrate, so that light transmission of the protective layer may be the same per unit area, which has a technical effect of improving a display effect of the display screen.

A technical solution of the embodiments provides the fibrous layer may be further set to have multiple fibers that are parallel to each other and that are arranged at equal intervals, and a manner in which materials of the multiple fibers are set to high rigidity fibers may be further combined, so as to improve the abrasion resistance of the protective layer, thereby having a technical effect that the protective layer can be deformed along a particular direction and is not broken.

Although example embodiments have been described, those skilled in the art may make additional alterations and modifications on these embodiments. Therefore, the appended claims are intended to be interpreted as covering example embodiments and all alterations and modifications falling within the ability of those having skill in the art.

It will be apparent to those skilled in the art that various modifications and variations can be made to the example embodiments without departing from the spirit and scope of the disclosure. In view of the foregoing, the non-limiting example embodiments are to be construed as covering modifications and variations thereof.

What is claimed is:

1. A product, comprising:
a protective layer of a flexible display screen, including:
an elastic substrate that adheres to a surface of the flexible display screen, and
a fibrous layer arranged at least partially in the elastic substrate.

2. The product according to claim 1, wherein the fibrous layer is affixed in the elastic substrate.

3. The product according to claim 1, wherein the fibrous layer protrudes from the elastic substrate.

4. The product according to claim 1, wherein an adhesive strength between the elastic substrate and a surface of the flexible display screen is selected to obtain a predetermined transparency of the protective layer.

5. The product according to claim 1, wherein the fibrous layer is composed of a material that achieves an adhesive strength between the fibrous layer and the elastic substrate that is approximately greater than or equal to a predetermined adhesive strength.

6. The product according to claim 1, wherein the fibrous layer is coated with a surfactant.

7. The product according to claim 1, wherein a difference between a refractive index of the fibrous layer and a refractive index of the elastic substrate is approximately less than or equal to a threshold.

8. The product according to claim 1, wherein a cross-sectional diameter of the fibrous layer is less than or equal to a visible wavelength of light.

9. The product according to claim 1, wherein the ratio of a height that the fibrous layer is exposed from a surface of the elastic substrate to a thickness of the fibrous layer is a predetermined ratio.

10. The product according to claim 1, wherein the fibrous layer is selected from the group consisting of a mesh and multiple fibers that are parallel to each other and arranged at approximately equal intervals.

11. An electronic device, comprising:
a processor;
a flexible display screen operatively coupled to the processor; and
a protective layer affixed to the flexible display screen, wherein the protective layer comprises:
an elastic substrate that adheres to a surface of the flexible display screen, and
a fibrous layer arranged at least partially in the elastic substrate.

12. The electronic device according to claim 11, wherein the fibrous layer is affixed in the elastic substrate.

13. The electronic device according to claim 11, wherein the fibrous layer protrudes from the elastic substrate.

14. The electronic device according to claim 11, wherein an adhesive strength between the elastic substrate and the surface of the flexible display screen is selected to obtain a predetermined transparency of the protective layer.

15. The electronic device according to claim 11, wherein the fibrous layer is composed of a material that achieves an adhesive strength between the fibrous layer and the elastic substrate that is approximately greater than or equal to a predetermined adhesive strength.

16. The electronic device according to claim 11, wherein the fibrous layer is coated with a surfactant.

17. The electronic device according to claim 11, wherein a difference between a refractive index of the fibrous layer and a refractive index of the elastic substrate is approximately less than or equal to a threshold.

18. The electronic device according to claim 11, wherein a cross-sectional diameter of the fibrous layer is less than or equal to a visible wavelength of light.

19. The electronic device according to claim 11, wherein the ratio of a height that the fibrous layer is exposed from a surface of the elastic substrate to a thickness of the fibrous layer is a predetermined ratio.

20. A method, comprising:
obtaining a protective layer for a flexible display screen of an electronic device, wherein the protective layer comprises:
an elastic substrate that adheres to a surface of the flexible display screen, and
a fibrous layer arranged at least partially in the elastic substrate; and
applying the protective layer to a flexible display screen of the electronic device.
